(19) United States
(12) Patent Application Publication
(10) Pub. No.: US 2015/0086953 A1
(43) Pub. Date: Mar. 26, 2015

(54) SKILL BUILDING SYSTEM AND METHOD OF USE

(71) Applicant: Alexander Johansson, Corpus Christi, TX (US)

(72) Inventor: Alexander Johansson, Corpus Christi, TX (US)

(21) Appl. No.: 14/341,747

(22) Filed: Jul. 25, 2014

Related U.S. Application Data
(60) Provisional application No. 61/858,384, filed on Jul. 25, 2013.

(51) Int. Cl. G09B 5/12; A63B 69/38; G06F 17/30; A63B 24/00

(52) U.S. Cl. CPC G09B 5/12; A63B 24/0006; A63B 69/38; G06F 17/30876; A63B 2024/0012
USPC 434/247; 434/362

(57) ABSTRACT

A system and method of use directed to a skill building system is disclosed herein. More specifically, the present invention relates to a system and method of use for a skill building system which can be utilized by coaches, teachers, and/or instructors in teaching, developing, coaching, and/or monitoring athletes' and/or students' skills either in an individual setting, a group setting, or they could practice on their own. In one embodiment, the system is comprised of a main server and a client input and output device. Whereas, the main server is configured to store and manage the data files and elements for the system and whereas the main server is communicatively coupled to the client input and output device. In another embodiment, the client input and output device is configured to run a client application, which allows a coach, teacher, and/or instructor to develop skills of a student through the system.

### CROSS-REFERENCE TO RELATED APPLICATIONS

This application claims the benefit under Title 35 United States Code §119(e) of U.S. Provisional Patent Application Ser. No.: 61/858,384; Filed: Jul. 25, 2013, the full disclosure of which is incorporated herein by reference.

### STATEMENT REGARDING FEDERALLY SPONSORED RESEARCH OR DEVELOPMENT

Not applicable

### THE NAMES OF THE PARTIES TO A JOINT RESEARCH AGREEMENT

Not applicable

### INCORPORATING-BY-REFERENCE OF MATERIAL SUBMITTED ON A COMPACT DISC

Not applicable

### SEQUENCE LISTING

Not applicable

### FIELD OF THE INVENTION

The present invention generally relates to a system and method of use directed to a skill building system. More specifically, the present invention relates to a system and method of use for a skill building system which can be utilized by coaches, teachers, and/or instructors in teaching, developing, coaching, and monitoring athletes' and/or students' skills either in an individual setting or in a group setting.

### BACKGROUND OF THE INVENTION

Without limiting the scope of the disclosed system and method, the background is described in connection with a novel system and approach directed to a skill building system.

In current coaching environments, the coach works one on one with students in developing them as a player in a particular sport. For example, in tennis the coach may have a session with a student working on serves or the forehand swing. This approach is not as effective or efficient as it could be. For instance, constant repetition and evaluation is required during the session and this requires the physical presence of the coach with the student. Also with this approach, there is no reference skill set and tracking of sessions and progress. For example, if there are multiple coaches involved, each coach may teach a serve a little bit different. Adding to this issue is that there are no tracking of sessions and progressions to compare to as the student continues through their development. In addition, in a student group setting the coaching session is tailored to a particular skill without any consideration of the skill level, progress, and weaknesses of the individual students. Also, communication with the group during and between practices is often cumbersome and often leads to miscommunications. With even larger group settings with assistant coaches, support staff, and parents involved, the issues are magnified even more. That is, it is important to have the students receive consistent and accurate information. Currently, there are no collaborative skill building management systems in place that allows the coach and student to facilitate effective practices either physically present or remote while maintaining effective communications individually or in a group setting.

While all of the aforementioned approaches may fulfill their unique purposes, none of them fulfill the need for a practical and effective means for providing a collaborative skill building management system.

The present invention therefore proposes a novel system and method of use for a collaborative skill building management system.

### BRIEF SUMMARY OF THE INVENTION

The present invention, therefore, provides a system and method of use for a skill building system. More specifically, the present invention relates to a system and method of use for a skill building system which can be utilized by coaches, teachers, and/or instructors in teaching, developing, coaching, and/or monitoring athletes' and/or students' skills either in an individual setting or in a group setting.

In one embodiment, the system is comprised of a main or central server and a client input and output device. Whereas, the main server is configured to store and manage the data files and elements for the system and whereas the main server is communicatively coupled to the client input and output device. In another embodiment, the client input and output device is configured to run a client application, which allows a coach, teacher, and/or instructor to develop the skills of a student through the system. This is accomplished by providing a collaborative communication platform through the system where the coach, teacher, and/or instructor can share personalized coaching information with the student such as videos, text, links, voice messages, graphs, and charts. The student may also share the same type of information and track training and workout sessions. Historical information is stored and tracked so that the progress of the student can be monitored and future coaching sessions can me more specifically tailored to the individual or group of students.

In summary, the present invention generally relates to a system and method of use directed to a skill building system. More specifically, the present invention relates to a system and method of use for a skill building system which can be utilized by coaches, teachers, and/or instructors in teaching, developing, coaching, and monitoring athletes' and/or students' skills either in an individual setting or in a group setting.

### BRIEF DESCRIPTION OF THE SEVERAL VIEWS OF THE DRAWINGS

For a more complete understanding of the features and advantages of the present invention, reference is now made to the detailed description of the invention along with the accompanying figures in which:

FIG. 1 is a system architecture diagram of the skill building system in accordance with embodiments of the disclosure;

FIG. 2 is a top level coaching functionality map diagram of the skill building system in accordance with embodiments of the disclosure;

FIG. 3 is a skills level coaching functionality map diagram of the skill building system in accordance with embodiments of the disclosure;

FIG. 4 is a binder level coaching functionality map diagram of the skill building system in accordance with embodiments of the disclosure;

FIG. 5 is a top level student functionality map diagram of the skill building system in accordance with embodiments of the disclosure;

FIG. 6 is a skills level student functionality map diagram of the skill building system in accordance with embodiments of the disclosure;

FIG. 7 is a client display illustration of the mode selection within the skill building system in accordance with embodiments of the disclosure;

FIG. 8 is a client display illustration of the student selection within the skill building system in accordance with embodiments of the disclosure;

FIG. 9 is a client display illustration of the student profile module within the skill building system in accordance with embodiments of the disclosure;

FIG. 10 is a client display illustration of the skills module within the skill building system in accordance with embodiments of the disclosure;

FIG. 11 is a client display illustration of the feedback and evaluation module within the skill building system in accordance with embodiments of the disclosure;

FIG. 12 is a client display illustration of the feedback and evaluation module within the skill building system with three skills being evaluated in accordance with embodiments of the disclosure;

FIG. 13 is a client display illustration of the group's commonality lesson module within the skill building system showing the common lesson results in accordance with embodiments of the disclosure;

FIG. 14 is a client display illustration of the group's commonality lesson module within the skill building system showing the group results in accordance with embodiments of the disclosure;

FIG. 15 is a client display illustration of the group's 3D path module within the skill building system showing the initial selections and setup in accordance with embodiments of the disclosure;

FIG. 16 is a client display illustration once the 3D path module is selected, where the user can select practice or new path within the skill building system in accordance with embodiments of the disclosure;

FIG. 17 is a client display illustration of the group's 3D path module within the skill building system showing a forehand spin practice and capture in accordance with embodiments of the disclosure; and

FIG. 18 is a client display illustration of the group's 3D path module within the skill building system showing the motion capture screen for the 3D path module in accordance with embodiments of the disclosure.

### DETAILED DESCRIPTION OF THE INVENTION

Disclosed herein is a system and method of use for a skill building system which can be utilized by coaches, teachers, and/or instructors in teaching, developing, coaching, and monitoring athletes' and/or students' skills either in an individual setting or in a group setting. In addition, the system may be utilized by a solo user to develop themselves without any interaction with others. The numerous innovative teachings of the present invention will be described with particular reference to several embodiments (by way of example, and not of limitation).

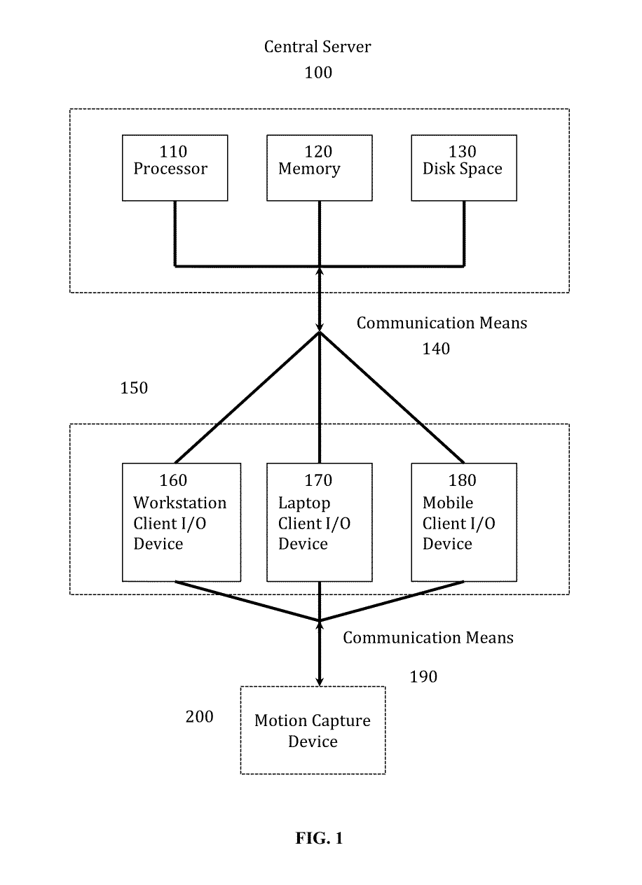

Reference is first made to FIG. 1, a system architecture diagram of the skill building system in accordance with embodiments of the disclosure. In one embodiment, the system is comprised of a main or central server 100 and a client input and output device or also referred to as a client display 150. The main server 100 having at least a processor 110 for processing instructions, memory (transitory computer-readable storage medium) 120 to support processing operations, and disk space (non-transitory computer readable storage medium) 130 or a similar functioning component for the storage of data. That is data such as but not limited to textual data elements, image files, video, links, charts, graphs, and voice messages. The client input and output device 150 having at least the means for receiving information from the main server 100, the means to present that information to the user, and the ability to send information back to the main server 100 for processing and/or storage. In another embodiment, the client input and output device may be a workstation 160, a laptop 170, or a mobile device 180. Whereas, the main or central server 100 is configured to store and manage the data elements or information for the system and whereas the main or central server 100 is communicatively coupled 140 to the client input and output device 150. In another embodiment, the client input and output device 150 is configured to run a client application, which allows a coach, teacher, and/or instructor to develop the skills of a student through the system. This is accomplished by providing a collaborative communication platform through the system where the coach, teacher, and/or instructor can share personalized coaching information with the student such as videos, text, links, voice messages, graphs, and charts. The student may also share the same type of information and track training and workout sessions. That is users of the system may be any individual associated with the coaching and development of the student such as but not limited to those already mentioned: coaches, teachers, instructors, students, parents, trainers, and counselors. Historical information is stored and tracked so that the progress of the student can be monitored and future coaching sessions can be more specifically tailored to the individual or group of students.

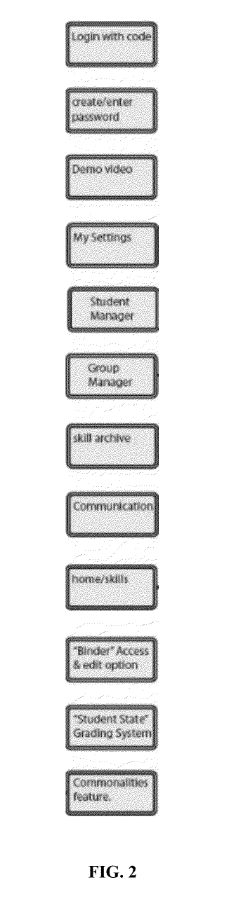

Reference is next made to FIG. 2, a top level coaching functionality map diagram of the skill building system in accordance with embodiments of the disclosure. In one embodiment, there are two main user groups of the skill building system. These two groups are the coach and the student. The client input and output device will have a presentation layer that may consist of a web interface or a client application, as examples and not an exclusive list. FIG. 2 provides one embodiment layout map for the presentation layer on the input and output device 150 for the coach user group. Here we can see the following base options presented to the coach user: login with code, create/enter password, demo video, my settings, student manager, group manager, skill archive, communication, home/skills, binder access and edit option, student state grading system, and commonalities feature. Within each of these options, the coach user can navigate the options to achieve the desired result in sharing information with the student or student group. In addition, groups may be created with supporting staff members, additional coaches, and parents being members. That is everyone working with the student can be connected or have access to the student's information. This creates the ultimate collaborative aid to a student and his/her development. Under settings, the following options are presented: alerts and evaluations, access settings, code management, and profile. Under student manager, the following options are presented: add/remove, profile input, assign to group, assign codes, alerts, access settings, IM settings, and evaluation form. Under group manager, the following options are presented: add/remove players and information input. Under skill archive, the following options are presented: search by skills and upload, search all files and upload, and add media and upload. Under communication, the following options are presented: with student, with select parties, and with group. Under home/skills, the following options are presented: pick an area of work and skills.

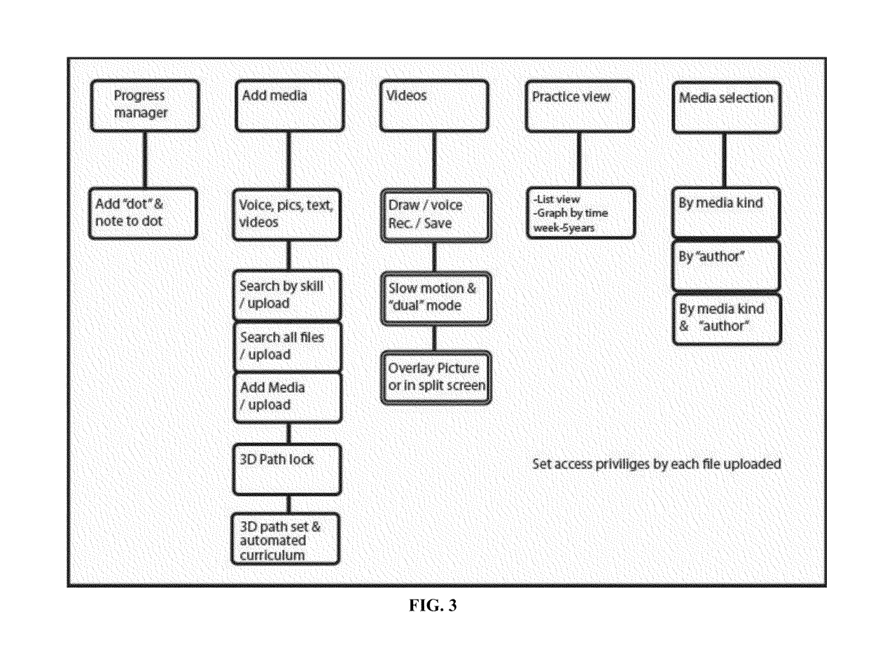

Reference is now made to FIG. 3, a skills level coaching functionality map diagram of the skill building system in accordance with embodiments of the disclosure. For each skill under the home/skills option, the following are presented: progress manager, add media, videos, practice view, and media selection. These options allow the tailoring of textual matter, videos, audio, and/or images with the skills. For instance a video of a forehand along with textual matter or notes can be attached to a skill such as a forehand swing. In an embodiment, the coach must approve content (skills, images, files, etc.) uploaded into the system by others in his group such as but not limited to supporting staff members, students, additional support coaches, and parents. This may be accomplished by receiving alerts on new content uploaded, reviewing the content, and approving the content so that others in the group may view.

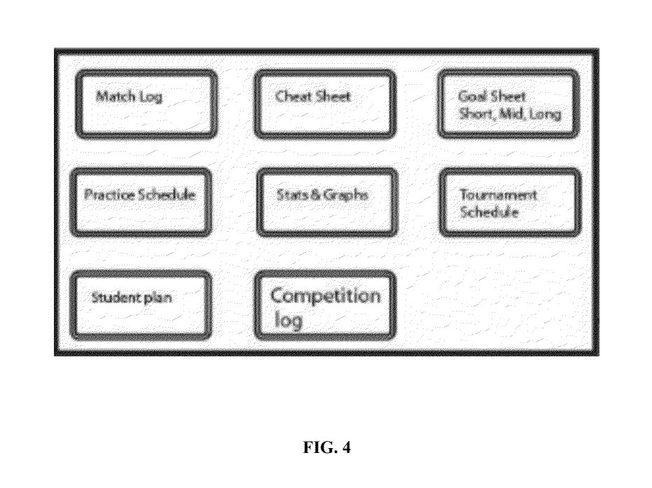

Reference is next made to FIG. 4, a binder level coaching functionality map diagram of the skill building system in accordance with embodiments of the disclosure. Under the binder access and edit option, the following is presented: match log, cheat sheet, goal sheet, practice log, stats and graph, tournament schedule, student plan, and competition log. These options allow additional tracking and monitoring for skills development. This binder level functionality is also available with the student functionality setup.

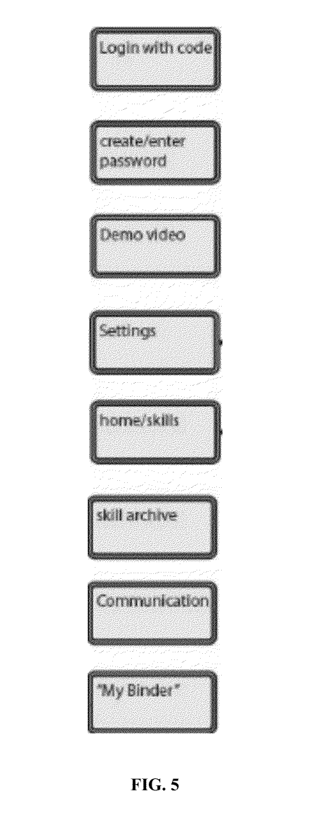

Reference is now made to FIG. 5, a top level student functionality map diagram of the skill building system in accordance with embodiments of the disclosure. FIG. 5 provides an embodiment layout map for the presentation layer on the input and output device 150 for the student user group. Here we can see the following base options presented to the student user:.login with code, create/enter password, demo video, settings, home/skills, skill archive, communication, and my binder. Within each of these options, the student user can navigate the options to achieve the desired result in sharing or reviewing information with the coach, student group, or practice on their own. Under settings, the following options are presented: alerts, access settings, and profile input and code distribution. Under home skills, the following options are presented: pick an area of work and skills.

Reference is next made to FIG. 6, a skills level student functionality map diagram of the skill building system in accordance with embodiments of the disclosure. For each skill under the home/skills option, the following are presented: add media, videos, practice view, and media selection.

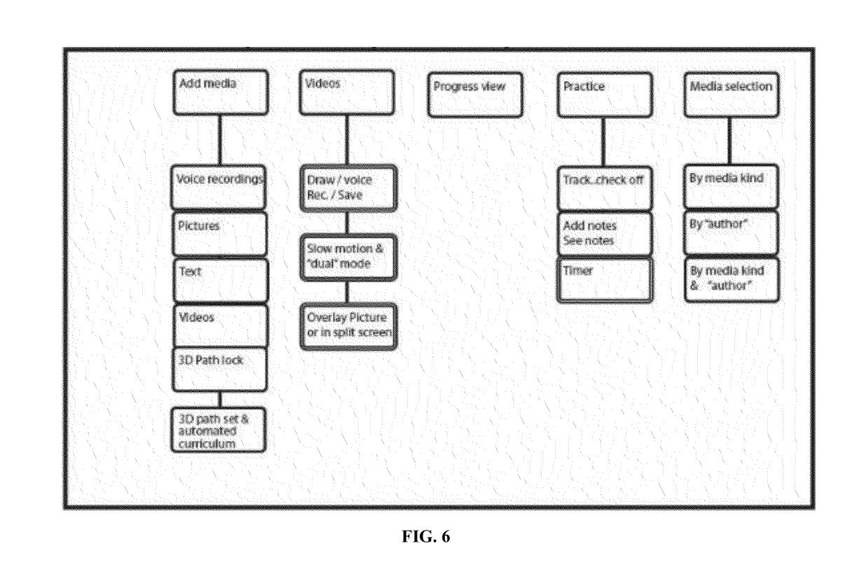

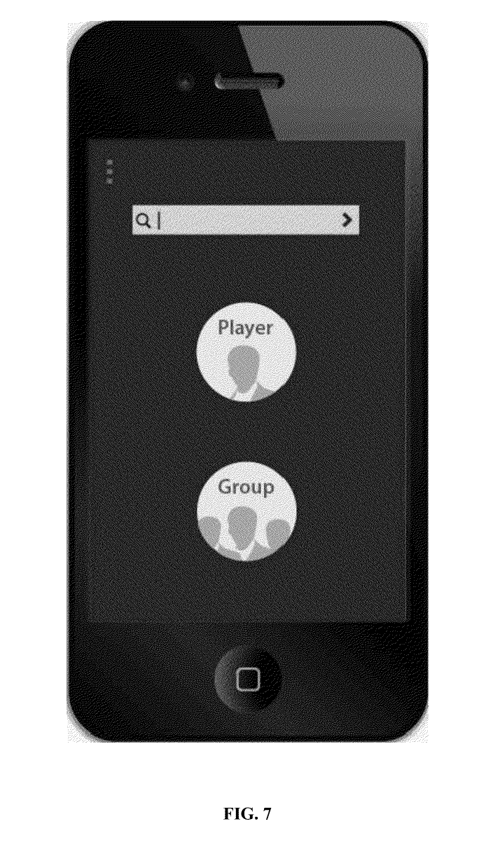

Reference is now made to FIG. 7, a client display 150 illustration of the mode selection within the skill building system in accordance with embodiments of the disclosure. Here illustrated is a screen which allows the user to select the individual player option or the group option while also providing a search field to lookup particular groups or players.

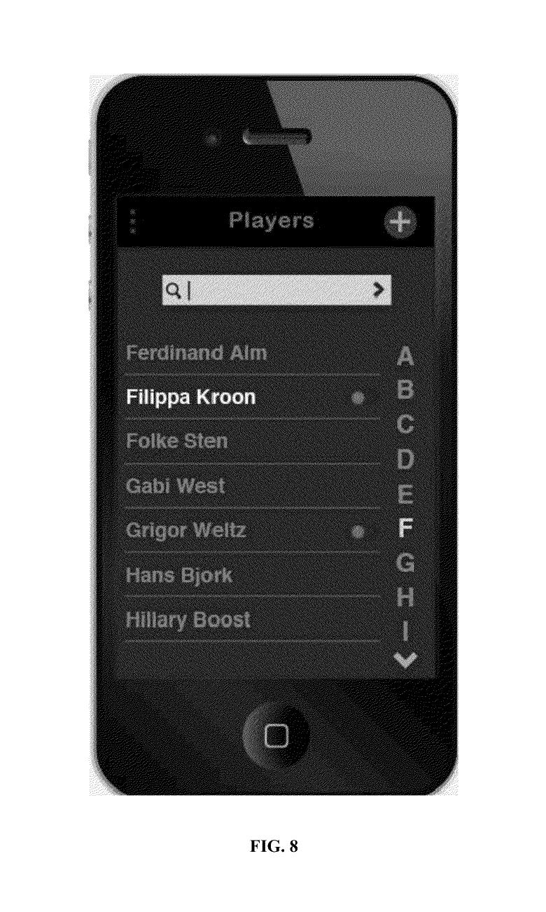

Reference is next made to FIG. 8, a client display 150 illustration of the student selection within the skill building system in accordance with embodiments of the disclosure. Here illustrated is the individual player option listing the students so that the user may drill down into an individual student's profile. which contains their skill and other background.

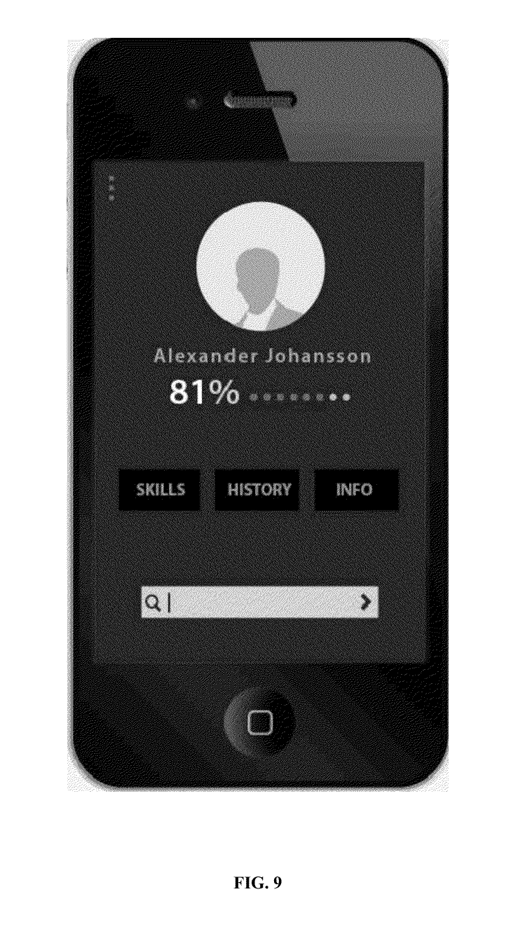

Reference is now made to FIG. 9, a client display 150 illustration of the student profile module within the skill building system in accordance with embodiments of the disclosure. Once a student is selected, the profile information can be viewed. This information is partitioned into three areas: skills, history, and information. These areas contain information such as but not limited to age, height, weight, rank, class, address, contact information, learning style, and schedule.

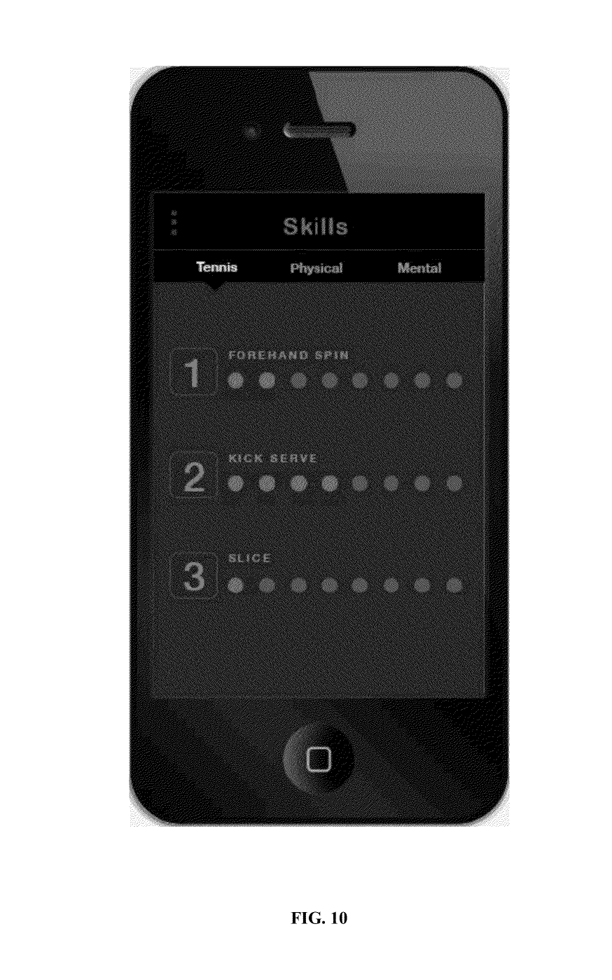

Reference is next made to FIG. 10, a client display 150 illustration of the skills module within the skill building system in accordance with embodiments of the disclosure. Here illustrated is an embodiment where the skills are viewable by the user. The skills are partitioned by the sport (tennis), physical, and mental. Under tennis, three skills are assigned: forehand spin, kick serve, and slice. Next to each skill are eight dots which are indicators as to the skill level they are at. By skill level, those skilled in the art will appreciate that this may take on various embodiments such as the level percentage of where the coach wants them to be or some other desired level to be achieved. That is the skill is completed or achieved when the coach believes the student has reached the desired level or has completed the skill. In an embodiment, the evaluation may be based on the coaches opinion or some objective standard. If four dots are filled, they are at a fifty percent skill level for that skill. If six dots are filled, they are at a seventy percent skill level for that skill. Within the system, limits may be placed on the type of skills assigned as well as the number of skills assigned under each category. The skill building system allows coaches, instructors, and teachers to assign, skill build, monitor, and evaluate the skills assigned to each student. Skill building is accomplished by assigning skills to students that they work on. With each assigned skill comes audio instruction, video instruction, textual instruction, and/or feedback all provided through the interface so that students can receive the proper instruction and reinforcement while in class or remotely while away out of class. These items may be assigned to a skill based on the student's learning style. For example, a visual learner may have only video instruction within their skills assigned. These items serve as reference material available to the user at all times and the user can practice the skills remotely by themselves without the coach, teacher, or instructor present physically. The ability to load skills along with the reference materials and provide feedback makes the system's information dynamic and up to date. A remote coach may create a curriculum for a group. Preset skill specific drills can also be uploaded to the drill library for the remote coach and/or the coach on site to use for substitution as the skill commonalities within the group add up or change.

Reference is now made to FIG. 11, a client display 150 illustration of the feedback and evaluation module within the skill building system in accordance with embodiments of the disclosure. In FIG. 11 is illustrated an evaluation completed on a student. Here illustrated are four areas assessed: improvement, physical effort, mental effort, and attitude. Along with the four areas, the coach may also add additional notes to relay to the student, assistant coaches, parents, and/or others setup within the system. The coach may assess the student remotely through videos uploaded by the student, their practice sessions recorded, and/or the 3D path capture as will be described. In FIG. 12, three skills are evaluated and this presentation presents the student's state on one screen. Here illustrated is one screen with the three skills evaluated and an overall evaluation number of 81%. This information is stored and allows comparison of historical data to assess the progress of the student. The evaluations can be conducted for each individual or a group. Alerts may be set for goal follow-up.

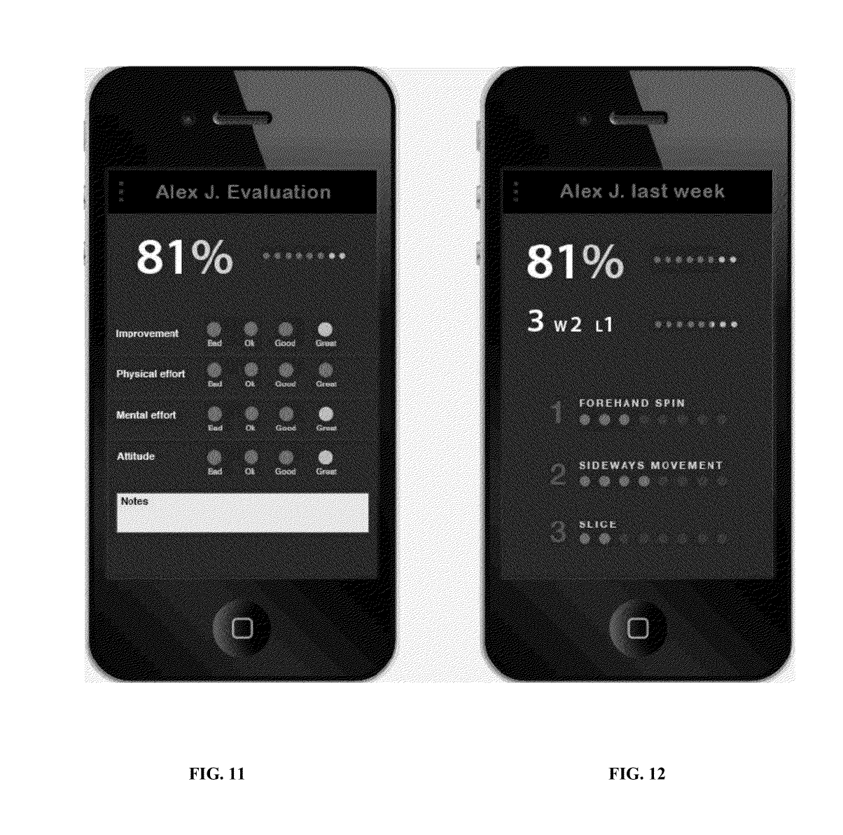

Reference is next made to FIG. 13, a client display 150 illustration of the group's commonality lesson module within the skill building system showing the common lesson results in accordance with embodiments of the disclosure. As mentioned herein, groups may be created with specific lessons planned for each of the groups. Another novel aspect to the system is that in the group module, an in common request can be made and the system will return the common skills being worked on for the group and can also override a preset plan and/or suggest substitute drills in a preset group practice plan automatically. This is helpful for a coach, instructor, and/or teacher in preparing lessons for the group so that the lesson is beneficial to the entire group and not just a few individuals. That is, the lessons can be tailored specifically to the needs of the group. In FIG. 14, the group results from the system are shown indicating the forehand, serve, and depth skills are the most common skills being worked on by the group. Also displayed is the number of students for each skill found in the group. A skill search can also be conducted to find students that are working on a particular skill.

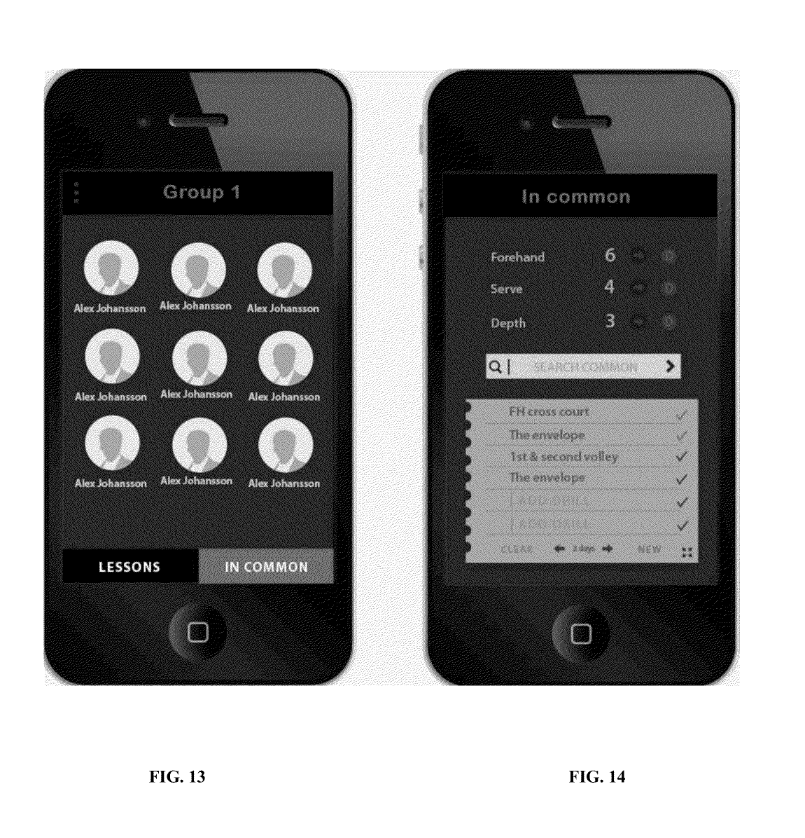

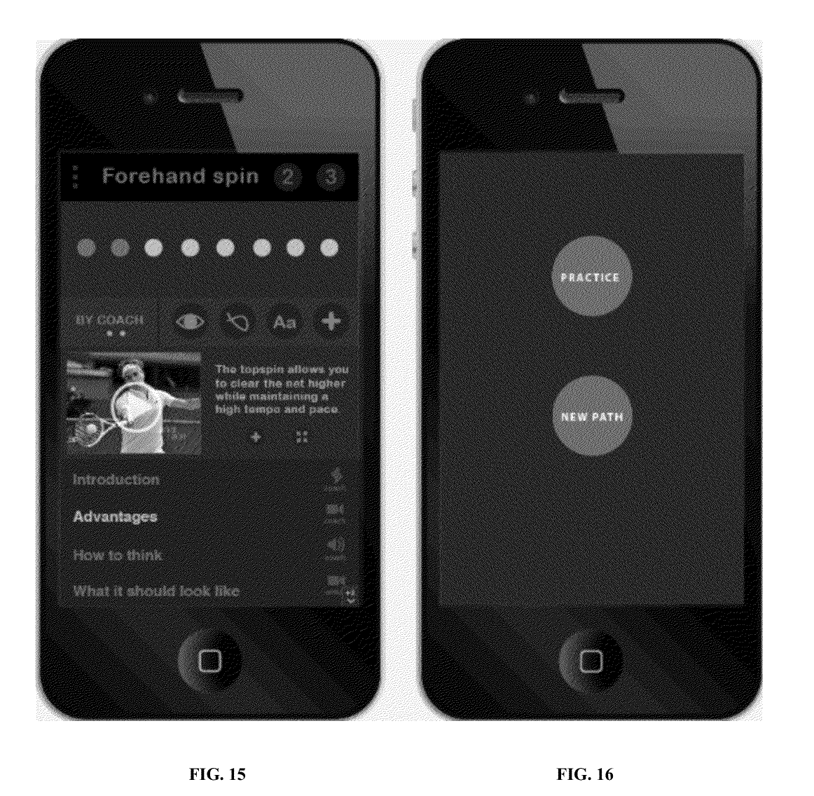

Reference is now made to FIG. 15, a client display 150 illustration of the group's 3D path module within the skill building system showing the initial selections and setup in accordance with embodiments of the disclosure. Illustrated in FIG. 15 is a skill client display for the system. Here illustrated is the forehand spin. This is an example of a skill, which can be assigned to a student. Tagged underneath the skill are additional coaching items provided for the student. These additional items for this skill are: introduction, advantages, how to think, and what it should look like. Next to each item are icons indicating the type of link or file the item is. For “introduction”, it is of type text. For “advantages”, it is of type video. For “how to think”, it is of type audio. And lastly, for “what it should look like”, it is of type video. When an item is selected, it is displayed in the center of the screen. In this illustration, “advantages” is selected. With each skill these coaching items can be added or deleted to tailor the information. The skill level is also presented at the top of the display for the student. From this client display, an icon, allows the selection of the 3D path module. Once the 3D path module is selected, the display will present what is illustrated in FIG. 16. From the here the user can select practice or new path. The practice selection allows the user to practice the skill in the 3D path module, while the new path selection allows the addition of a new skill motion model.

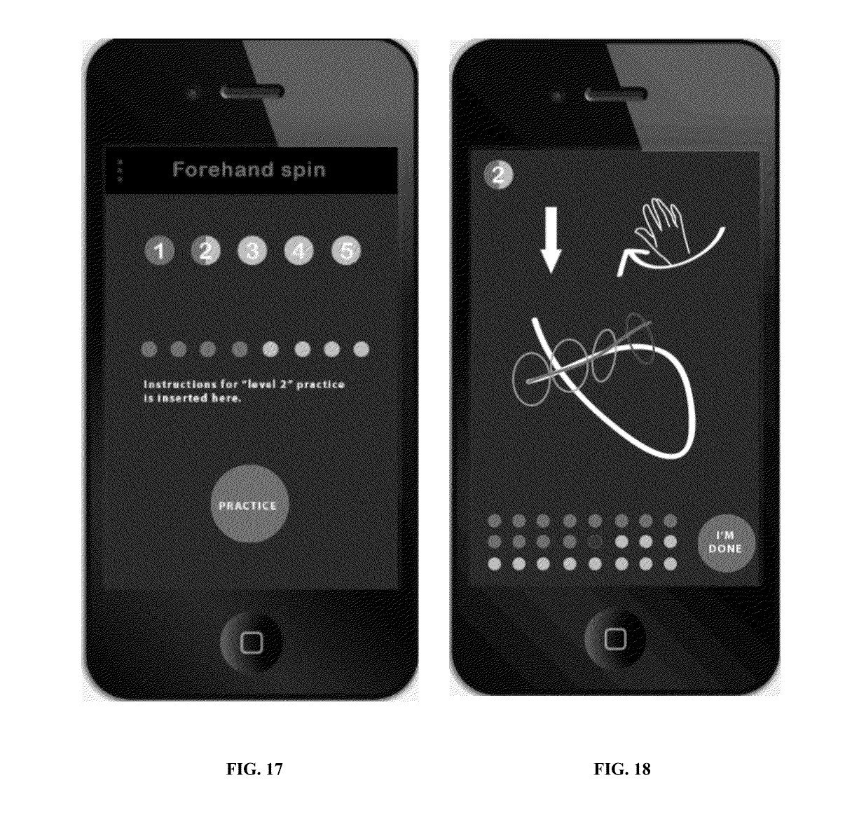

Reference is lastly made to FIG. 17, a client display 150 illustration of the system's 3D path module within the skill building system showing a forehand spin practice and capture in accordance with embodiments of the disclosure. In FIG. 17 illustrated is the forehand spin practice. Indicated is the level of the student for the skill to be practiced along with instructions on how to execute the skill. The smaller eight dots indicate the level of completion of the repetitions for that skill. Once the student is ready, the practice icon is selected on the display interface. In FIG. 18, illustrated is the motion capture screen for the 3D path module. What is occurring here is the user has now placed a motion capture device 200 on their hand which is communicatively coupled 190 with the client input and output device 150. The actual motion of the user performing the skill is compared to a model of the motion with the comparison and results of the analysis provided to the user through the client display 150. The model of the motion may be, as an example, the coach's recorded path to serve as a referenced desired motion. The model of the motion is the current desired motion and a coach might evolve the form of the movement or stroke in stages to develop the student. In addition, as the user performs the skill, the system provides automatic audio and visual feedback to the user as the comparison of the user performing the skill and the model is being compared in real time. For example, the racket is being brought too far back. In other embodiments, depending on the skill being taught, the motion capturing devices 200 may be placed at various locations on the user to capture the necessary motion. For example, in soccer, the motion capturing devices 200 may be placed on the users' feet and legs. The small dots at the bottom of the client display represent the level of completion of the repetitions for that skill. The 3D path module provides for a dynamic and automated curriculum to the student user. In another embodiment, the student has to match the model of the motion a set number of times in order to pass the level and ultimately have reinforced the correct motion the desired amount of times.

In brief, as described herein provides for an effective and efficient system and method of use for a skill building system which can be utilized by coaches, teachers, and/or instructors in teaching, developing, coaching, and monitoring athletes' and/or students' skills either in an individual setting or in a group setting.

The disclosed system and method of use is generally described, with examples incorporated as particular embodiments of the invention and to demonstrate the practice and advantages thereof. It is understood that the examples are given by way of illustration and are not intended to limit the specification or the claims in any manner.

To facilitate the understanding of this invention, a number of terms may be defined below. Terms defined herein have meanings as commonly understood by a person of ordinary skill in the areas relevant to the present invention.

Terms such as “a”, “an”, and “the” are not intended to refer to only a singular entity, but include the general class of which a specific example may be used for illustration. The terminology herein is used to describe specific embodiments of the invention, but their usage does not delimit the disclosed device or method, except as may be outlined in the claims.

Alternative applications for this invention include using the system and method of use for skill building in various environments and conditions besides the field of athletics. For example, the system may be employed in various training and development environments where skills and practices are to be taught such as in the field of music. Consequently, any embodiments comprising a one component or a multi-component system having the structures as herein disclosed with similar function shall fall into the coverage of claims of the present invention and shall lack the novelty and inventive step criteria.

It will be understood that particular embodiments described herein are shown by way of illustration and not as limitations of the invention. The principal features of this invention can be employed in various embodiments without departing from the scope of the invention. Those skilled in the art will recognize, or be able to ascertain using no more than routine experimentation, numerous equivalents to the specific device and method of use described herein. Such equivalents are considered to be within the scope of this invention and are covered by the claims.

All publications and patent applications mentioned in the specification are indicative of the level of those skilled in the art to which this invention pertains. All publications and patent application are herein incorporated by reference to the same extent as if each individual publication or patent application was specifically and individually indicated to be incorporated by reference.

In the claims, all transitional phrases such as “comprising,” “including,” “carrying,” “having,” “containing,” “involving,” and the like are to be understood to be open-ended, i.e., to mean including but not limited to. Only the transitional phrases “consisting of” and “consisting essentially of,” respectively, shall be closed or semi-closed transitional phrases.

The system and/or methods disclosed and claimed herein can be made and executed without undue experimentation in light of the present disclosure. While the system and methods of this invention have been described in terms of preferred embodiments, it will be apparent to those skilled in the art that variations may be applied to the system and/or methods and in the steps or in the sequence of steps of the method described herein without departing from the concept, spirit, and scope of the invention.

More specifically, it will be apparent that certain components, which are both shape and material related, may be substituted for the components described herein while the same or similar results would be achieved. All such similar substitutes and modifications apparent to those skilled in the art are deemed to be within the spirit, scope, and concept of the invention as defined by the appended claims.

What is claimed is:

1. A system for managing, evaluating, and building skills comprising:
a central database server;
at least one client input and output device communicatively coupled to said central database server and said client input and output device is configured for sending and receiving coaching and skills information to and from said central database server for presenting said information to users of the system through said input and output devices;
said central database server configured to process, store, and manage coaching and skills information received from said client input and output devices.

2. The system of claim 1, wherein the central database server is further comprised of:
one or more processors;
a non-transitory computer-readable storage medium;
a transitory computer-readable storage medium.

3. The system of claim 1, wherein said client input and output device is a workstation;

4. The system of claim 1, wherein said client input and output device is a laptop;

5. The system of claim 1, wherein said client input and output device is a mobile device;

6. The system of claim 1, wherein said system is further configured to present information by coach or student groups based on the user's assigned group.

7. The system of claim 6, wherein said system is further configured to present information by additional custom groups.

8. The system of claim 7, wherein said additional groups are comprised of at least one of supporting staff members, additional coaches, or parents.

9. The system of claim 6, wherein said system is further configured to manage said coaching group's information based on student manager, group manager, skill archive, communication, home/skills, binder access, student state grading system, and commonalities functions.

10. The system of claim 6, wherein said system is further configured to manage said coaching group's information based on a player or group selection by user.

11. The system of claim 6, wherein said system is further configured to manage said student group's information based on demo video, home/skills, skill archive, communication, and my binder functions.

12. The system of claim 6, wherein said system is further configured to manage student skills by allowing coaches to evaluate assigned said skills and store said evaluations for review by at least coaches and students.

13. The system of claim 1, wherein said system further comprises a motion capture device communicatively coupled to said input and output device.

14. The system of claim 13, wherein said system is further configured to allow models of motion to be uploaded for comparison against the actual motion of the user captured by said motion capture device with the results of said comparison provided to at least the student.

15. The system of claim 14, wherein said models of motion are sports movements.

16. The system of claim 15, wherein said models of motion are tennis movements.

17. The system of claim 6, wherein said system is further configured to manage said coaching group's information based on a commonalities function which allows said coach to obtain for a student group those skills in common that are being worked on.

18. The system of claim 6, wherein said system is further configured for said coaching students to be assigned lessons tailored to each individual.

19. The system of claim 6, wherein said system is further configured for said coaching student groups to be assigned lessons tailored to each group.

20. A system for managing, evaluating, and building skills comprising:
a central database server;
at least one client input and output device communicatively coupled to said central database server and said client input and output device is configured for sending and receiving coaching and skills information to and from said central database server for presenting said information to users of the system through said input and output devices;
said central database server configured to process, store, and manage coaching and skills information received from said client input and output devices;
wherein said client input and output device is a workstation, laptop, or mobile device;
wherein said system is further configured to present information by coach, student, and additional custom groups based on the user's assigned group;
wherein said system is further configured to manage said coaching group's information based on student manager, group manager, skill archive, communication, home/skills, binder access, student state grading system, and commonalities functions;
wherein said system is further configured to manage said student group's information based on demo video, home/skills, skill archive, communication, and my binder functions;
wherein said system further comprises a motion capture device communicatively coupled to said input and output device;
wherein said system is further configured to allow models of motion to be uploaded for comparison against the actual motion of the user captured by said motion capture device with the results of said comparison provided to at least the student;
wherein said system is further configured to manage said coaching group's information based on a commonalities function which allows said coach to obtain for a student group those skills in common that are being worked on;
wherein said system is further configured for said coaching students to be assigned lessons tailored to each individual;
wherein said system is further configured for said coaching student groups to be assigned lessons tailored to each group.
